(19) United States
(12) Patent Application Publication
(10) Pub. No.: US 2014/0012680 A1
(43) Pub. Date: Jan. 9, 2014

(54) Directed Advertising and Educational Information Systems

(71) Applicants: Jett Wayne Puckett, Rome, GA (US); Lucas M. Jennings, Rome, GA (US); Robert K. Finnell, Rome, GA (US); A. Steven Nugent, IV, Atlanta, GA (US); Scott E. Brient, Roswell, GA (US)

(72) Inventors: Jett Wayne Puckett, Rome, GA (US); Lucas M. Jennings, Rome, GA (US); Robert K. Finnell, Rome, GA (US); A. Steven Nugent, IV, Atlanta, GA (US); Scott E. Brient, Roswell, GA (US)

(73) Assignee: X APP, LLC

(21) Appl. No.: 13/543,549

(22) Filed: Jul. 6, 2012

(51) Int. Cl. G06Q 30/02

(52) U.S. Cl. 705/14.66

(57) ABSTRACT

Directed advertising and educational information systems according to particular embodiments include an academic portion and a token portion. In various embodiments, the academic portion is configured to display educational information to a user. The educational information may include grade information, information about homework assignments, school news, and other educational information. In particular embodiments, the token portion is configured to display offers to the user based at least in part on the educational information. In various embodiments, the offers may include a donation to a particular organization such as an educational institution. In particular embodiments, the system is configured to receive an indication of products be purchased by a user from a particular business and automatically adjust the price of those products to reflect a discount to which the user is entitled based on the user's association with an organization or based on offers available from the system's token portion.

### BACKGROUND

Advertising plays an important role in facilitating the sale of products and services to customers. Advertisers are constantly seeking new ways to advertise. Accordingly there is a need for new and unique advertising systems and methods.

### SUMMARY OF VARIOUS EMBODIMENTS

A computer system, according to various embodiments, comprises at least one processor and memory. In particular embodiments, the computer system is configured for: (1) receiving educational information for at least one student of a particular educational institution; (2) receiving an indication that an advertiser wishes to display an advertisement to at least one individual selected form a group consisting of: (a) students who satisfy predetermined criteria; and (b) relatives of students who satisfy the predetermined criteria; (3) using the educational information to determine whether the student satisfies the predetermined criteria; and (4) in response to determining that the student satisfies the predetermined criteria, displaying the advertisement to one or more individuals selected form a group consisting of: (a) the student; and (b) one or more relatives of the student.

A non-transitory computer-readable medium, according to various embodiments, stores computer-executable instructions for: (1) retrieving educational information about a user; (2) selecting at least one advertisement based at least in part on the educational information about the user; and (3) displaying the at least one advertisement to the user.

A computer system, according to various embodiments, comprises at least one processor and memory. In particular embodiments, the computer system is configured for: (1) receiving an indication of at least one product to be purchased by a customer; (2) receiving an indication of an organization associated with the customer; (3) identifying any special offers available to persons associated with the organization which apply to the at least one product to be purchased by the customer; and (4) applying the special offers to a purchase price of the at least one product to be purchased by the customer.

### BRIEF DESCRIPTION OF THE DRAWINGS

Having thus described various embodiments in general terms, reference will now be made to the accompanying drawings, which are not necessarily drawn to scale, and wherein:

FIG. 1 is a block diagram of a system according to one embodiment.

FIG. 2 is a block diagram of a Directed Advertising Server of FIG. 1.

FIG. 3 is a flowchart showing steps executed by a Directed Advertising module according to a particular embodiment.

FIG. 4 is a flowchart showing steps executed by a Coupon Redemption Module according to a particular embodiment.

FIG. 5 is a screen shot of a first basic interface of a Directed Advertising and Educational Information System according to a particular embodiment.

FIG. 6 is a screen shot of a second basic interface of a Directed Advertising and Educational Information System according to a particular embodiment.

FIG. 7 is a screen shot of an Academic Portion of the Directed Advertising and Educational Information System of FIG. 6.

FIG. 8 is a screen shot of a Token Portion of the Directed Advertising and Educational Information System of FIG. 6.

### DETAILED DESCRIPTION OF VARIOUS EMBODIMENTS

Various embodiments now will be described more fully hereinafter with reference to the accompanying drawings. It should be understood that the invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Overview

A Directed Advertising and Educational Information System, according to particular embodiments, includes: (1) a school portion that allows students, parents, or others to access educational information about a student; and (2) a token portion that distributes special offers (e.g., coupons) and/or other advertisements to users of the application.

The educational information maintained by the system's school portion may include information such as a student's class schedule, grades, homework assignments and due dates, the student's disciplinary record, relevant school news, and other academic information. The token portion may be configured to generate and/or distribute advertisements that include special offers such as, for example, traditional coupons, or “frenzy coupons” that need to be activated by a particular number of users in order to be redeemable. In various embodiments, the token portion may direct advertisements to users based, at least in part, on a student's educational information and/or other information stored by the system. For example, a student that participates in a particular club may receive, from the token portion, advertisements that are relevant to the club's activities (e.g., students in photography club may receive discount coupons for 20% off of photo prints at a particular store that develops/prints photographs).

In particular embodiments, the token portion may be configured to generate advertisements and to direct the advertisements and/or special offers (e.g., discounts) to students based on any suitable information obtained from the system's school portion. Such information may include, for example: (1) the student's gender; (2) the student's age; (3) one or more particular courses that the student has taken in the past, is currently enrolled in, or is enrolled to take in the future; (4) the student's current class (e.g., freshman, sophomore, etc. . . . ); (5) one or more of the student's extracurricular activities (e.g., clubs, athletic teams, or other organizations that the student is a member of); (6) the student's past or current performance in school (e.g., the student's grades in a particular course, overall GPA, and/or class rank; (7) the nature of the student's classes (e.g., honors or AP classes, or special education classes); (8) academic or other information regarding the student's siblings; (9) the frequency of the student's pictures in school publications, such as school yearbooks; (10) leadership positions held by the student; (11) performance-related honors that have been bestowed on the student (e.g., academic or athletic honors); (12) any work-study programs (e.g., co-ops or internships) that the student participates in; (13) homework assignments; (14) upcoming scheduled activities (e.g., scheduled athletic events or field trips); (15) the student's attendance record; (16) any other suitable information; or (17) any combination of the above types of information.

For example, the token portion may be configured to generate and/or distribute advertisements that include discounts for manicures to female members of the school's cheerleading squad. As another example, students who have maintained at least a 3.5 grade point average in English may receive a discount on books purchased from a local bookstore (since such students are more likely than others to purchase books on a regular basis).

In particular embodiments, the token portion may also be configured to generate advertisements and/or distribute advertisements to non-student users of the system. Such users may include, for example: (1) parents of students; (2) teachers; (3) school administrators; and/or (4) alumni.

In particular embodiments, any time a user redeems a coupon or offer with the business making the offer, a designated percentage or particular amount of the sale made during the redemption will be donated to a particular educational institution. In certain embodiments, the advertisements disclosed herein may include an offer under which the offering party would make a contribution to the educational institution generally and/or to a particular entity associated with the educational institution if the offer is accepted. For example, the offer may specify that 10% of any purchase made using a particular coupon for art supplies will be donated to the school's art department.

In particular embodiments, the system may be used to automatically apply available discounts or special offers (e.g., coupons) to purchases made by a customer. For example, the system may receive an indication that multiple products (e.g., various items at a grocery store) are to be purchased by a customer. The system then receives an indication that the customer satisfies certain criteria. The determination that the customer satisfies certain criteria may be based, for example, on information obtained from the system's academic portion (e.g., that the student recently made the school's academic honor roll). The system then identifies any special offers that are available to members of the organization and that apply to the products to be purchased by the customer (e.g., the system may apply a 10% discount off of all books that is only available to students who are listed on a particular school's academic honor roll). Finally, the system automatically adjusts the price of the items to reflect the special offers. Such an embodiment may allow users to receive special offers without, for example, clipping coupons.

Exemplary Technical Platforms

As will be appreciated by one skilled in the relevant field in light of this disclosure, various embodiments of the present invention may be, for example, embodied as a computer system, a method, or a computer program product. Accordingly, various embodiments may take the form of an entirely hardware embodiment, an entirely software embodiment (e.g., one or more computer application, such as an “app” to be implemented on a mobile device and/or an application to be implanted on a desktop computer), or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each block of the block diagrams and flowchart illustrations, and combinations of blocks in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, blocks of the block diagrams and flowchart illustrations support combinations of mechanisms for performing the specified functions, combinations of steps for performing the specified functions, and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and other hardware executing appropriate computer instructions.

Exemplary System Architecture

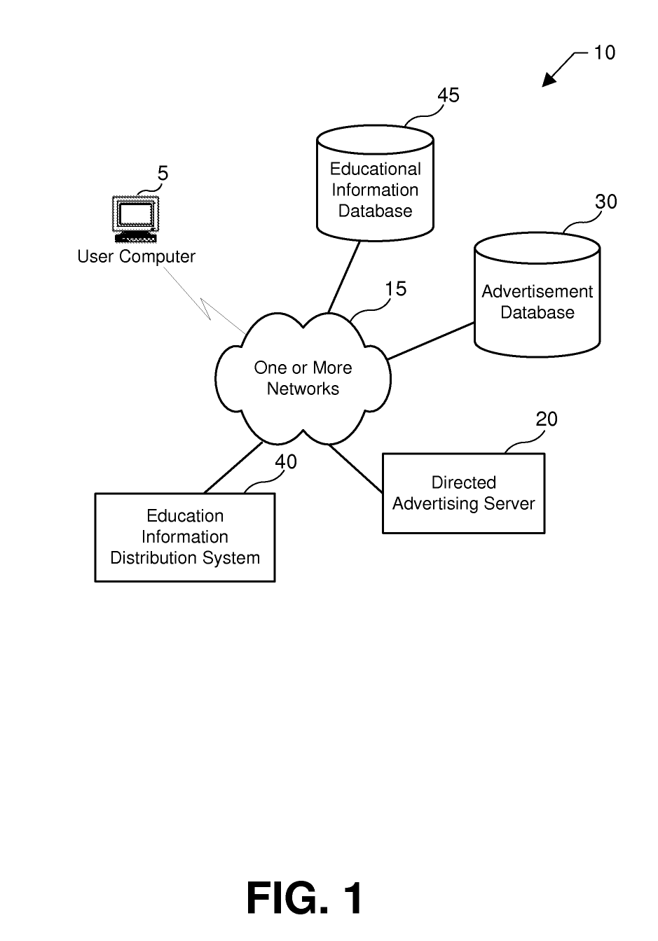

FIG. 1 shows a block diagram of a Directed Advertising and Education Information System 10 according to a particular embodiment. As may be understood from this figure, the Directed Advertising and Education Information System 10 includes at least one User Computer 5 (e.g., a wireless computing device such as a tablet computer or smart phone, laptop, or other suitable computer), one or more computer networks 15, a Direct Advertising Server 20, an Advertisement Database 30, an Education Information Distribution System 40, and an Educational Information Database 45. The one or more computer networks 15 facilitate communication between the User Computer 5, Directed Advertising Server 20, Advertisement Database 30, Education Information Distribution System 40, and Educational Information Database 45. These one or more computer networks 15 may include any of a variety of types of computer networks such as the Internet, a private intranet, a public switch telephone network (PSTN), or any other type of network known in the art. In certain variations of the embodiment shown in FIG. 1, the communication links between the User Computer 5, Directed Advertising Server 20, Advertisement Database 30, Educational Information Distribution System 40, and Educational Information Database 45 may be implemented via the Internet and/or via a suitable Local Area Network (LAN).

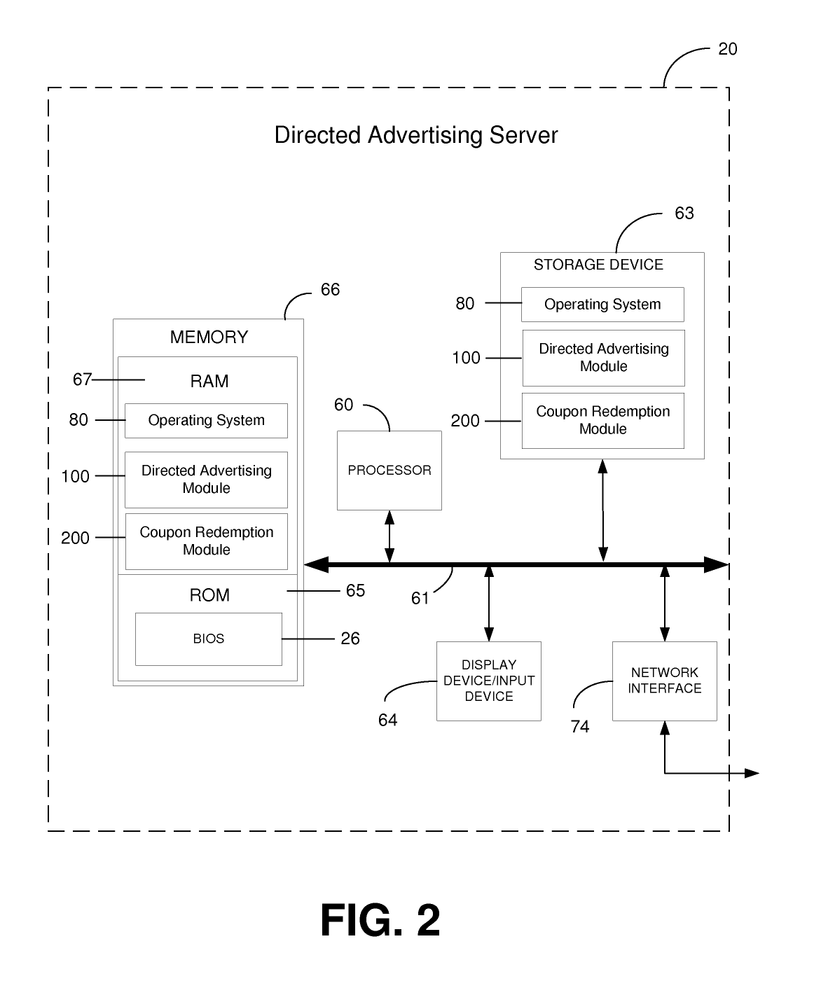

FIG. 2 shows a block diagram of an exemplary embodiment of the Directed Advertising Server 20 of FIG. 1. The Directed Advertising Server 20 includes a processor 60 that communicates with other elements within the Directed Advertising Server 20 via a system interface or bus 61. The Directed Advertising Server 20 may, in various embodiments, include a display device/input device 64 for receiving and displaying data. This display device/input device 64 may be, for example, a keyboard, voice recognition, or pointing device that is used in combination with a monitor. The Directed Advertising Server 20 further includes memory 66, which preferably includes both read only memory (ROM) 65 and random access memory (RAM) 67. The server's ROM 65 is used to store a basic input/output system 26 (BIOS) that contains the basic routines that help to transfer information between elements within the Directed Advertising Server 20.

In addition, the Directed Advertising Server 20 includes at least one storage device 63, such as a hard disk drive, a floppy disk drive, a CD Rom drive, or optical disk drive, for storing information on various computer-readable media, such as a hard disk, a removable magnetic disk, and/or flash memory. As will be appreciated by one of ordinary skill in the art, each of these storage devices 63 is connected to the system bus 61 by an appropriate interface. The storage devices 63 and their associated computer-readable media provide nonvolatile storage for the Directed Advertising Server 20. It is important to note that the computer-readable media described above could be replaced by any other type of computer-readable media known in the art. Such media include, for example, magnetic cassettes, flash memory cards, and digital video disks.

A number of program modules may be stored by the various storage devices and within RAM 67. Such program modules include an operating system 80, a Directed Advertising Module 100, and a Coupon Redemption Module 200. The Directed Advertising Module 100 and Coupon Redemption Module 200 control certain aspects of the operation of the Directed Advertising Server 20, as is described in more detail below, with the assistance of the processor 60 and an operating system 80.

Also located within the Directed Advertising Server 20 is a network interface 74 for interfacing and communicating with other elements of a computer network. It will be appreciated by one of ordinary skill in the art that one or more of the Directed Advertising Server 20 components may be located geographically remotely from other Directed Advertising Server 20 components. Furthermore, one or more of the components may be combined, and additional components performing functions described herein may be included in the Directed Advertising Server 20.

### Exemplary System Modules

As noted above, various aspects of the system's functionality may be executed by certain system modules, including the system's Directed Advertising Module 100 and Coupon Redemption Module 200. These modules are discussed in greater detail below.

Directed Advertising Module

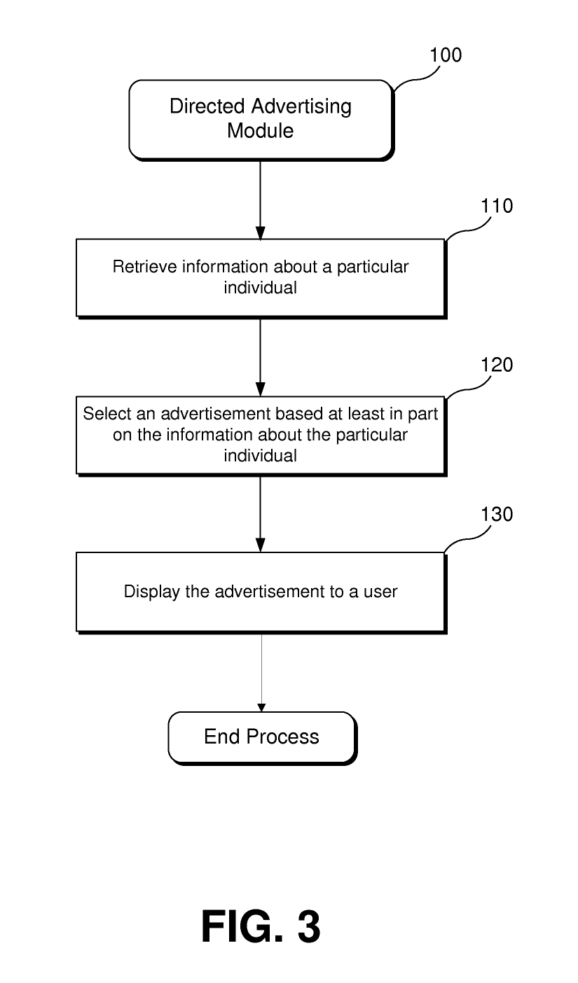

FIG. 3 is a flow chart of an exemplary Directed Advertising Module 100. As may be understood from this figure, certain embodiments of the Directed Advertising Module 100 are configured to generate and/or direct advertisements to users of the Directed Advertising and Educational Information System based at least in part on information about the users. For example, as discussed above, the system may direct advertisements, including one or more special offers, to users based on education information stored within the system.

At step 110, the system retrieves information about a particular individual (e.g., a user of the system, who may—for example—be a particular student, a relative of a particular student, or an educational institution employee). The system may retrieve this information, for example, from the Educational Information Database 45. As discussed above, such information may include, for example, education information, such as a particular student's grade point average, current homework assignments, attendance information, calendar of activities, clubs, athletic or academic teams, etc. . . . In addition, the system may retrieve general demographic information for the student, such as the student's age, gender and/or address.

It should be understood that the “user” of the system may, in some instances, be the student or the student's legal guardian. In particular embodiments, at step 110, the system may retrieve information both about a non-student user of the system and about a student affiliated with the user. For example, if a particular student's mother is currently accessing the system, the system retrieves information regarding the mother (e.g., her gender, age, address, number of children and other relevant information), and also information about the particular student. As discussed below, such information may be used to select an appropriate advertisement for the user.

At step 120, the system selects an advertisement for the user, based at least in part on the information from the Educational Information Database 45. In various embodiments, the advertisement may be based, at least in part, on a particular student's educational information. For example, if the system determines that the user is a student with a grade point average at or above 3.75, the system may display a coupon for a free e-book from an online bookseller. In other embodiments, the system may be configured to direct advertisements to students based on age, gender and/or any of the other factors discussed above. For example, all female high school students who are juniors or seniors may receive a coupon for 10% off of homecoming dresses at a local dress shop.

While the advertisements may be in the form of promotions and/or coupons that benefit the users directly, the advertisements may, for example, also result in a donation back to a particular school when the user redeems a coupon or otherwise accepts a particular offer. For example, an advertisement may indicate that a particular car dealership will donate $100 to the school when a user redeems a particular coupon at the car dealership.

In particular embodiments, advertisements or offers may include a guarantee that the company making the offer or placing the advertisement will make a donation to a particular school, but may not include any discounts directly to the user that redeems the offer. For example, in the car dealership example above, the $100 donation that the car dealership promises to donate to the user's school may be the only benefit received from purchasing a car at the dealership (e.g., the user may not receive an additional discount on the car for claiming the offer). In such embodiments, users of offers may desire to benefit their school or other educational institution while making purchases that they already planned on making (e.g., the user will select a particular car dealership because that particular car dealership has promised to donate to their school).

At step 130, the system then displays the selected advertisement to the user, for example, via an electronic display on a computer or mobile device, or via an electronic message, such as an e-mail or text message.

Coupon Redemption Module

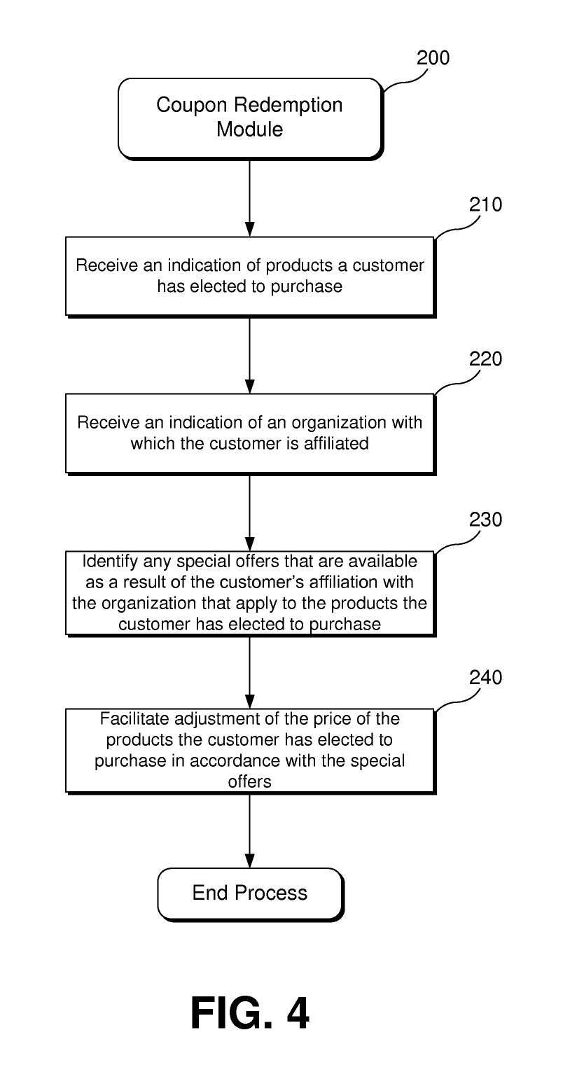

FIG. 4 is a flow chart of an exemplary Coupon Redemption Module 200. At step 210, the system receives an indication of what products a customer has elected to purchase (e.g., at a particular retail location or on a particular web site). For example, the customer may have chosen to purchase multiple items at a grocery store. The system may receive the indication of the items to be purchased in any suitable manner. In certain embodiments, the system receives this indication when the customer manually enters the items they wish to purchase into the system. In other embodiments, the customer may scan items as they shop (e.g., using barcode-reading OCR software that is built into the user's mobile device). In other embodiments, the system may receive the indication of purchases to be made from a Point Of Sale computer at a retail location (e.g., after a cashier “scans’ the goods at checkout).

At step 220, the system receives an indication of an organization that the customer is affiliated with. For example, the system may receive an indication that the customer is a parent of a child who attends a particular educational institution, that the customer is on the football team of a particular school, etc. . . . It should be understood that the organization may be any suitable organization such as a particular school, church, or other organization.

At step 230, the application identifies special offers that are available as a result of the customer's affiliation with the organization, and that apply to the items that the customer wishes to purchase. For example, students at a particular educational institution may be eligible to receive a 20% discount at a particular movie theater, or members of a school alumni association may receive 5% off the purchase of a particular book at a local bookstore.

Finally, at step 240, the system facilitates adjusting the price of the purchased products to reflect the discount to which the customer is entitled based on their association with the organization. In the movie theater example above, the system would reduce a $75 bill to $60. In particular embodiments, the system may do this by, for example: (1) transmitting a suitable message to a point of sale computer that is being used to check out the customer, (2) by coordinating payment to the user of the amount of the savings; or (3) though any other suitable method.

### Exemplary User Interface

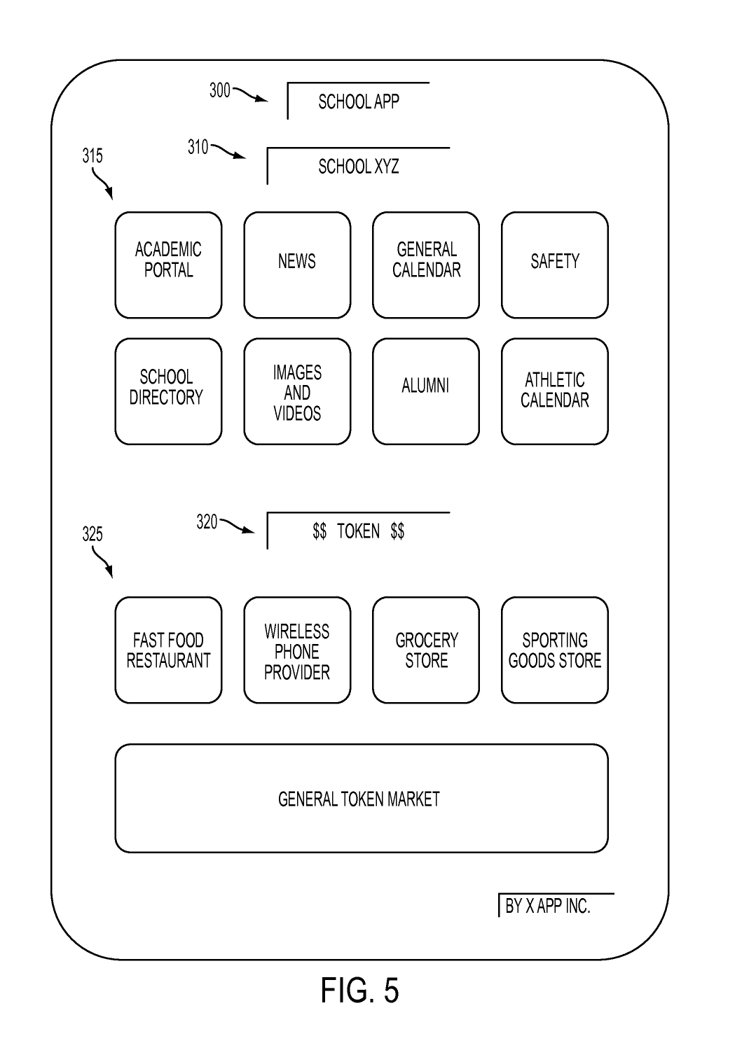

An exemplary user interface 300 for a particular embodiment of a Directed Advertising and Educational Information System 10 is shown in FIG. 5. This figure represents the user interface 300 of an application running on a mobile device, but a similar interface may be used on tablet computers, desktop computers, laptops, and other similar devices. This interface 300 may be used by users to access various aspects of the system. In particular embodiments, the system is adapted to facilitate communication between the wireless device and a central server that, for example, may store one or more of the databases discussed above.

In the embodiment shown in FIG. 5, the application home page is divided into two sections. The top half contains an Academic Portion 310, while the bottom half displays a Token Portion 320, which may, for example, include advertisements and other offers.

In the embodiment shown in FIG. 5, the Academic Portion 310 comprises eight tabs 315 that the user may access (e.g., via a touch screen of a mobile device). These eight tabs 315 include an Academic Portal, a News tab, a General Calendar, a Safety Tab, a School Directory Tab, an Images and Videos Tab, an Alumni Tab, and an Athletic Calendar. In particular embodiments, the Academic Portion 310 provides the user with access to some or all of the academic information referred to earlier in this document.

Due to differences in screen size and graphical capabilities between computers and handheld devices, user interfaces may differ depending on the device that the user accesses the system. As mentioned earlier, a user interface such as the user interface shown in FIG. 5 may, for example, be particularly suitable for accessing the system via a tablet or smartphone.

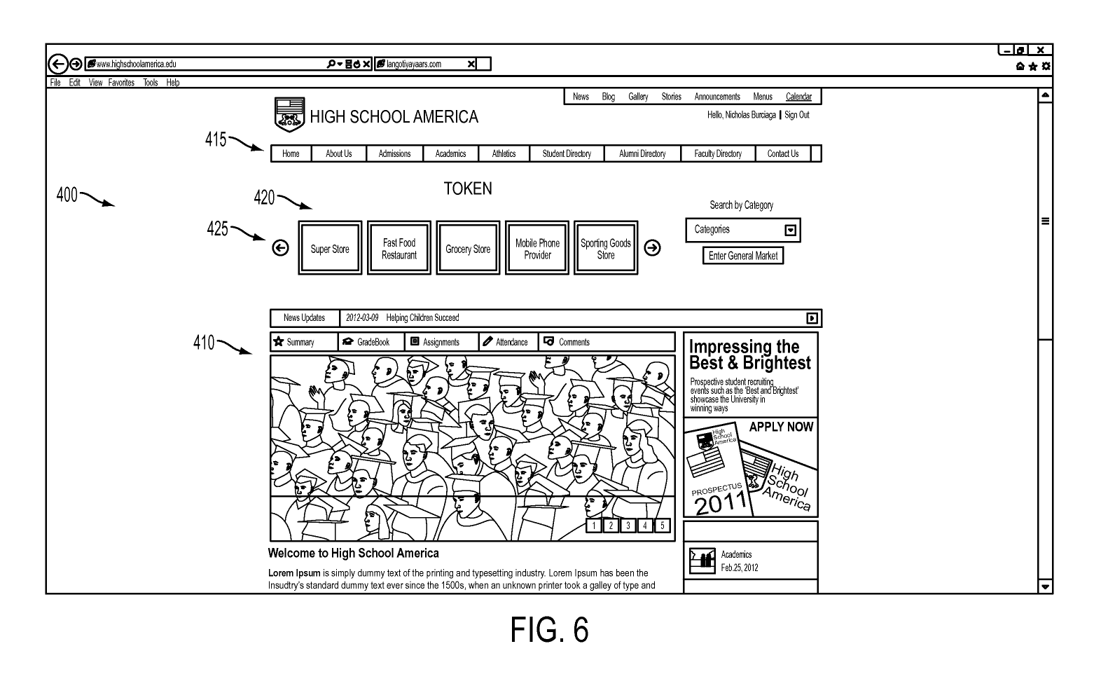

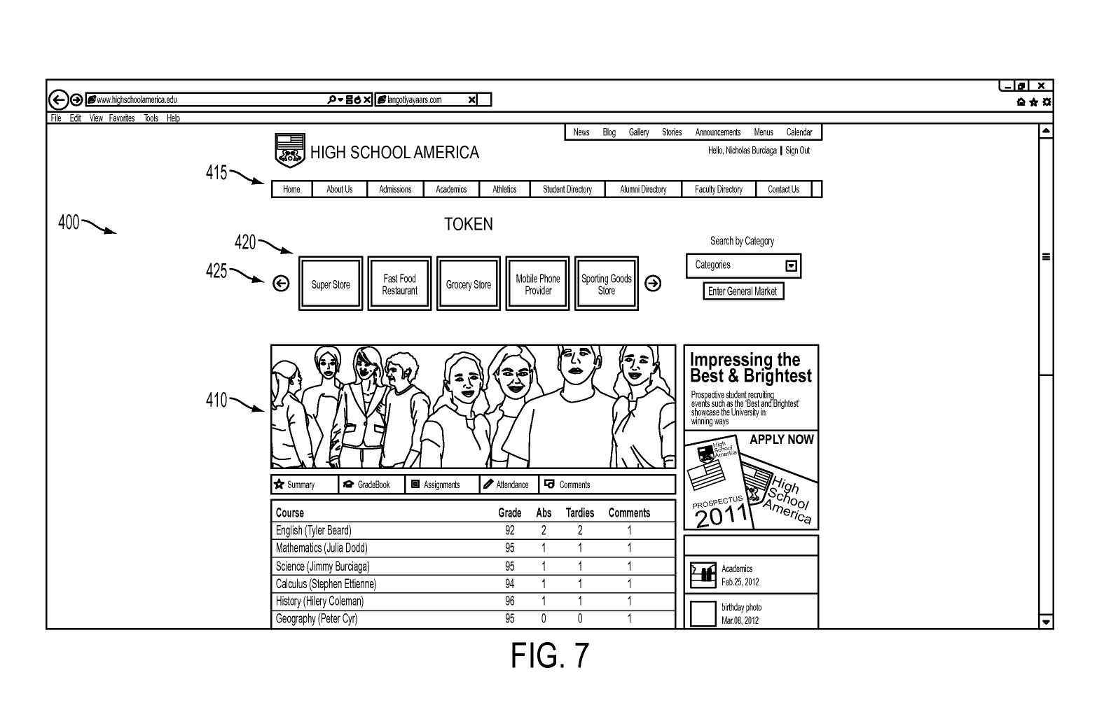

The embodiment shown in FIGS. 6-8 are screen displays of a user interface 400 according to another embodiment. As may be understood from FIGS. 6-8, these figures may represent a user interface 400 that is adapted to be displayed on a personal computer (e.g., via a web browser or other suitable application). FIG. 6 shows an exemplary home screen of a user interface that includes an Academic Portion 410 and a Token Portion 420. As may be understood from these figures, the Academic Portion 410 may include various tabs 415 that allow a user to access particular information (e.g., admissions information, academic information (e.g., a particular student's grades, homework assignments, attendance records, disciplinary reports, etc. . . . ), athletic information, a student directory, an alumni directory, and/or a faculty directory). In various embodiments, the Token Portion 420 may include links to advertisements, offers, rewards, and/or similar deals that are made available from particular companies (e.g., fast food restaurants, grocery stores, mobile phone providers, etc.). The system may generate and/or display advertisements on the user interface's Token Portion 420 based on any of the criteria discussed above (e.g., the system may display any particular advertisements, offers and/or discounts to the user based whether the user and/or individuals associated with the user qualify for those offers, which may be contingent on the user or other individual meeting particular requirements, such as membership in a particular organization and/or maintaining a certain grade point average.)

In various embodiments, the user interface may include customizable templates. Users may customize the user interface with school colors, logos, etc. In other embodiments, user interfaces may include even more customizable features (e.g., custom user profiles, sponsored background graphics, and other features). In particular embodiments, the user interface may comprise a “contact us” page and a campus map. Teachers and administrators may access the user interface to update and upload information and data (e.g., academic records of particular students). In various embodiments, students and parents may have constant access to view this data and information. Teachers, parents, students, and alumni may be able to access all of the features described above via, for example, suitable user interfaces such as those shown in FIGS. 5-8.

The user interface of FIG. 5 will now be described in greater detail. This figure displays a basic interface may be used to access the Directed Advertising and Educational Information System via a wireless device. The following sections explain each button or tab, on the interface.

Academic Portion

In particular embodiments, the Academic Portion enables teachers and administrators to upload and update student course information, including class schedules, individual student grades, student attendance information, overall class grade averages, and teacher comments. In various embodiments, the Academic Portion may also include a general assignments page that will display current and future homework assignments for each class. In particular embodiments, each class will have a grade book that displays the student's overall average, the class average, and categories of assignments, such as tests, quizzes, reports, and homework. Information accessible via the specific tabs 315 displayed in FIG. 5 is described below.

News

In particular embodiments, the News section may include a streaming RSS feed that contains up-to-date news for a particular school. In various embodiments, this section contains general school news.

General Calendar

In particular embodiments, the General Calendar section displays a general school calendar that contains basic information such as school holidays, early dismissal days, the first and last days of school, and any information the school deems appropriate for the General Calendar.

Safety

In particular embodiments, the Safety section displays safety alerts. The school may use this section to post general alerts, and to send automatic mass text messages and e-mail messages to students and parents. The school may use this section, for example, to cancel or delay classes due to inclement weather or for any other reason. The Safety section may also include procedures for various “dangerous” situations (e.g., bomb threats, natural disasters, fires, etc.), and provide a direct way to speed dial police or campus security. In various embodiments, the school may post useful safety phone numbers in the Safety section, such as numbers for designated driver services, or a hazing or bullying hotline.

School Directory

In particular embodiments, the School Directory section contains contact information for students, parents, teachers, and alumni. In various embodiments, there may be a link to social media sites (e.g., facebook, twitter, etc.) that can be used to find and communicate with students, parents, teachers, and alumni, and to distribute “frenzy” coupons, which are discussed below.

Images and Video

In particular embodiments, the Images and Video section will contain various images and videos taken at a particular school or at school events. For example, this section may include pictures and video of a school dance, sporting event, or awards ceremony.

Alumni

In particular embodiments, the Alumni section may contain a link to join and/or renew alumni membership, a link to alumni discounts, a calendar of alumni events, a feature for finding alumni clubs, contact information for an alumni association, and/or any other information that may be of interest to an alumnus of a particular educational institution.

Athletic Calendar

In particular embodiments, the Athletic Calendar section may include dates, times, and locations of one or more upcoming athletic events for a particular educational institution. In various embodiments, the Athletic Calendar section may include access to up-to-date scores from school athletic events and any other information related to school athletics (e.g., team records, individual statistics, etc.).

Token Portion

In particular embodiments, the Token Portion allows businesses to post advertisements, special offers, and/or coupons to the system for distribution and/or display to various users of the system (e.g., using the techniques discussed above). As shown in FIG. 5, the Token Portion may include tabs for primary corporate sponsors of the application. In various embodiments, the Token Portion may also contain a link to a “General Token Market”. In particular embodiments, the “General Token Market” may allow businesses to input specific deals, offers, and advertisements for distribution and/or display by the system, and to optionally specify the criteria that should be used in distributing/displaying the deals, offers and/or advertisements.

For example, the Token Portion may allow a sponsoring restaurant to indicate that they will provide a free chicken sandwich to any student who made a particular school's honor roll in a particular semester. The system may be configured to allow the sponsor (e.g., the restaurant) to upload graphics and other information to be used within an advertisement that includes the special offer. In a particular embodiment, when a user logs into the system, the system determines whether the user or an individual related to the user qualifies for the offer (e.g., whether the user or any of the user's children made the school's honor roll in the indicated semester). If so, the system displays the offer to the user on the system's user interface screen. If not, the system does not display the offer to the user.

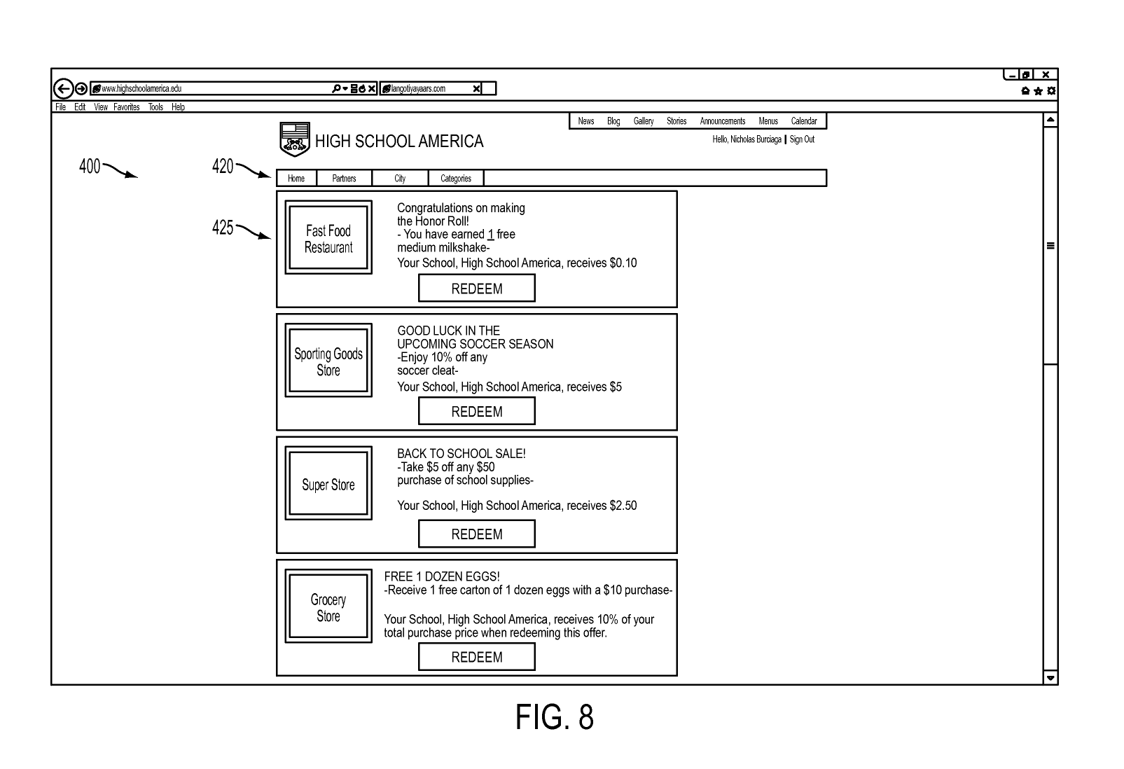

In various embodiments, the offers may include rewards for students (e.g., for academic performance). In particular embodiments, offers and advertisements may optionally include donations to be made by a sponsor to a specified educational institution if the user accepts a particular offer. For example, as shown in FIG. 8, an offer for 10% off of a soccer cleat at a sporting goods store may also specify that the store will make a $5 donation to a school when a student of the school redeems the offer.

In particular embodiments, each offer may include an amount of money or a percentage of the sale price that will be donated for the benefit of a specified educational institution if the user accepts the particular offer. In various embodiments, the amount of money (e.g., a specific amount such as $5.00 or a percentage of the price of items purchased when redeeming an offer) that will be donated to the particular educational institution may be displayed as part of the offer (e.g., such as the offers shown in FIG. 8). In such embodiments, the users will know the extent to which the educational institution will benefit when the user redeems the offer.

In various embodiments, when businesses post new advertisements or coupons, their corresponding tab may become highlighted, or the system may otherwise indicate to the user that that a particular business has a new offer available.

### Alternative Embodiments

### Frenzy Coupons

In particular embodiments, the system is configured to allow businesses to post “frenzy” coupons to the Token Portion of the web and mobile applications. Frenzy coupons may require a particular number of users to activate them before they become redeemable. For example, a coupon for 10% off at a particular grocery store may require 20 users to activate the coupon before any users can redeem the coupon. Frenzy coupons may result in higher discounts than, for example, a traditional coupon that does not require a minimum number of users to activate it before the coupon becomes usable. In various embodiments, users may be able to “spread the word” about frenzy coupons through social media applications, such as Facebook and/or Twitter.

Advertisements to People Associated with a Student

As discussed above, the system may direct advertisements to people associated with a particular student (e.g., the student's parents, grandparents, guardians, etc.) Sometimes, the students are not the true target market of the advertisement. For example, orthodontists' patients are teenagers or children. However, parents are typically the decision makers who actually pay for orthodontic treatment. Therefore, parents may be the actual target market for a particular business. This type of advertising can be further categorized to people associated with students within a particular age range, such as offering coupons for discounts at a car dealership to parents of children turning 16 years old.

Advertisements Directed toward Other Persons Associated with the School

Some embodiments may include directed advertisements for others associated with the school (e.g., school teachers, alumni, faculty, and administrators). The advertisements may be directed, for example, based on the user's association with the school (e.g., school supply discounts for teachers, etc.)

### CONCLUSION

Many modifications and other embodiments of the invention will come to mind to one skilled in the art to which this invention pertains having the benefit of the teachings presented in the foregoing descriptions and the associated drawings. For example, as will be understood by one skilled in the relevant field in light of this disclosure, the invention may take form in a variety of different mechanical and operational configurations. Therefore, it is to be understood that the invention is not to be limited to the specific embodiments disclosed and that the modifications and other embodiments are intended to be included within the scope of the appended exemplary concepts. Although specific terms are employed herein, they are used in a generic and descriptive sense only and not for the purposes of limitation.

1.-25. (canceled)

26. A computer system, comprising:
a processor, a memory, input and output and computer executable code,
a student information system having a student information database comprising a student information which comprises a student data regarding a first student and a non-student data regarding a non-student,
said first student being assigned rights to use the student information system,
said student data having been entered by said first student into said student information system,
said student data being a personal interest of said first student,
said personal interest having been entered into said student information system by said first student,
said student information system having a student information database comprising a non-student information which comprises a non-student data regarding a person who is a non-student,
said non-student being assigned rights to use the student information system,
said non-student data having been entered by said non-student into the student information system,
a database having a relationship data regarding a relationship between said first student and said non-student,
an advertising database having a student-based advertising criteria regarding said student data,
an advertising database having an non-student advertising criteria regarding said non-student data,
an executable code having a rule which identifies said first student matching said student-based advertising criteria based upon said student data when said personal interest of said first student matches said advertising criteria,
an executable code having a rule which matches said non-student to said first student based on said relationship criteria,
an advertisement database comprising advertising data for a non-student,
an executable code which identifies said non-student as matching a non-student advertising criteria based upon said relationship criteria,
an executable code matching said advertising data to said non-student based upon said student data,
said advertising data to said non-student based upon said personal interest of said student,
an executable code electronically communicating to said non-student said advertising data when said non-student matches said relationship criteria and said non-student matches said advertising data to said non-student which is based upon said student data, said student data being said personal interest of said first student.

27. The computer system according to claim 26, further comprising:
an advertisement database comprising advertising data for a first student,
an executable code matching said advertising data to said first student based upon said student data comprising said personal interest of said first student,
an executable code electronically communicating to said first student said advertising data.

28. The computer system according to claim 26, in which said data regarding a first student comprises an academic interest.

29. The computer system according to claim 26, in which said data regarding a first student comprises a non-academic interest.

30. The computer system according to claim 26, in which said data regarding a first student comprises an extracurricular activity of the first student.

31. The computer system according to claim 26, in which said data regarding a first student comprises a commercial product interest of said first student.

32. The computer system according to claim 26, in which said data regarding a relationship between said first student and said non-student comprises a data that the non-student is a parent of said first student.

33. The computer system according to claim 26, in which said data regarding a relationship between said first student and said non-student comprises a data that the non-student is a relative of said first student.

34. The computer system according to claim 26, in which said student information system comprises an executable code having a rule which identifies said non-student as matching a non-student advertising criteria based upon said non-student data.

35. The computer system according to claim 26, in which said data regarding a relationship between said first student and said non-student comprises a data that the non-student is a teacher or school administrator.

36. The computer system according to claim 26, in which said data regarding a non-student comprises a data regarding an organization the non-student is affiliate with.

37. The computer system according to claim 26, in which said data regarding a non-student comprises a data regarding an alumni status of the non-student.

38. The computer system according to claim 26, in which said data regarding a non-student comprises a data regarding a merchant through which the non-student is eligible to redeem an advertised coupon.

39. The computer system according to claim 26, in which said data regarding a non-student comprises a data regarding an eligibility of said first-student for an advertisement or commercial offer.

40. The computer system according to claim 26, in which said executable code matching said advertising data to said non-student executes said matching based upon a rule which finds a match when said first student is a child of said non-student

41. The computer system according to claim 26, in which said executable code matching said advertising data to said non-student executes said matching based upon a rule which finds a match when said non-student is an alumni of a school attended by said first student

42. The computer system according to claim 26, in which said executable code matching said advertising data to said non-student executes said matching based upon a rule which finds a match when said first student has an extracurricular activity and said non-student is in a target market for an advertisement.

43. The computer system according to claim 26, in which said executable code matching said advertising data to said non-student executes said matching based upon a rule which finds a match when said student is in a target market for an advertisement.

44. The computer system according to claim 26, in which said advertising data comprises a merchant data.

45. The computer system according to claim 26, in which said advertising data is communicated to a student and/or non-student when not logged into the student information system.
